(19) United States
(12) Patent Application Publication
(10) Pub. No.: US 2019/0042904 A1
(43) Pub. Date: Feb. 7, 2019

(54) Contactless IC card adhered with layers for showing holographic and laser images

(71) Applicant: Baoli HONG, Shenzhen (CN)

(72) Inventor: Baoli HONG, Shenzhen (CN)

(21) Appl. No.: 15/706,787

(22) Filed: Sep. 18, 2017

(30) Foreign Application Priority Data
Aug. 4, 2017 (CN) 201710661087.0

(51) Int. Cl. G06K 19/077; B32B 7/12; B32B 27/36; B32B 27/30

(52) U.S. Cl. CPC G06K 19/07722; B32B 7/12; B32B 27/36; B32B 2425/00; G06K 19/07749; B32B 2457/00; B32B 27/304

(57) ABSTRACT

A contactless integrated circuit (IC) card adhered with layers for showing holographic and laser images, having an IC chip and a card structure; the IC chip is disposed inside the card structure; the card structure has an upper card structure and a lower card structure; the upper card structure has a holographic polyester (PET)/polyvinyl chloride (PVC) laser plastic layer, a printing layer and a PET/PVC film layer sequentially arranged on the IC chip, with the holographic PET/PVC laser plastic layer being the nearest to the IC chip and the PET/PVC film layer farthest away from the IC chip; the holographic PET/PVC laser plastic layer is responsible for showing holographic and laser images; the printing layer has images printed thereon, and the PET/PVC film layer protects the holographic PET/PVC laser plastic layer and the printing layer.

### BACKGROUND OF THE INVENTION

The present invention relates to the making of integrated circuit cards, and more specifically relates to a contactless IC card adhered with layers for showing holographic and laser images.

An integrated circuit (IC) card has a card shape by inserting a microelectronic chip into a card base according to ISO 7816. An IC card can have a contact interface, a contactless interface or a contact and contactless dual interfaces, classified according to the type of communication interface the IC card uses. A contactless IC card is also called a RFID card, which comprises an IC chip and a sensor antenna, and is encapsulated within a standard PVC card; the IC chip and the antenna are not exposed to the external environment. Therefore, contactless IC card is a ground breaking product in the field of electronic components in being passive (no power source in the card) and contactless. A contactless IC card is highly reliable, easy to use, anti-collision (the ability to auto-identify), and has wide range of application and good performance in encryption. Contactless IC card is used in different fields like public transportation, telecommunication, banking, highway fee payment and car parking management etc. A contactless IC card is operable for data transmission via radio wave by being placed proximal to a reader by a predetermined distance (usually 40-50 mm).

In card making industry nowadays, a contactless IC card is generally printed on a single kind of material which is a plastic molded plastic sheet, and has an emission frequency of 13.56 Hz and a readable distance of around 40 mm. A printed surface of such contactless IC card is boring without variations. Since a thickness of an existing contactless IC card is more or less fixed, an existing method of enhancing the effect of images printed on the card surface is to adhere a film onto the card surface. However, this method will result in exceptionally weak emission frequency. As such, the wire coil of the chip layer has to be made with 1-2 additional coils, and the winding diameter of the wire coil has to be increased in order to strengthen the emission frequency. Accordingly, the chip layer has to be made individually for every batch of orders of relevant laser materials, and an additional 5-10 second/coil is required to make the chip layer. Therefore, there is an increase in material and labor costs for production, thereby increasing the general production cost, lowering the production efficiency and increasing defective product rate.

### BRIEF SUMMARY OF THE INVENTION

In view of the aforesaid disadvantages of the prior art, it is an object of the present invention to provide a contactless IC card adhered with layers for showing holographic and laser images, and a method of making the same.

To attain the above object, the present invention has the following technical scheme:

A contactless integrated circuit (IC) card adhered with layers for showing holographic and laser images, comprising an IC chip and a card structure; the IC chip is disposed inside the card structure; the card structure comprises an upper card structure and a lower card structure; the upper card structure comprises a holographic polyester (PET)/polyvinyl chloride (PVC) laser plastic layer, a printing layer and a PET/PVC film layer sequentially arranged on the IC chip, with the holographic PET/PVC laser plastic layer being the nearest to the IC chip and the PET/PVC film layer farthest away from the IC chip; the holographic PET/PVC laser plastic layer is responsible for showing holographic and laser images; the printing layer has images printed thereon, and the PET/PVC film layer protects the holographic PET/PVC laser plastic layer and the printing layer.

Preferably, the holographic PET/PVC laser plastic layer comprises a PET/PVC plastic layer, an adhesive layer, an integration layer, a metal-plated/nano material layer and a PET/PVC base film layer sequentially arranged, with the PET/PVC plastic layer being nearest to the IC chip and the PET/PVC base film layer being farthest away from the IC chip; the PET/PVC plastic layer fixes the IC chip and a general shape of the card structure; the adhesive layer adheres the PET/PVC plastic layer and the integration layer; the integration layer is a functional layer that carries out pre-processing according to holographic and laser imaging requirements; the metal-plated/nano material layer is a hologram layer; the PET/PVC base film layer protects the PET/PVC plastic layer, the adhesive layer, the integration layer and the metal-plated/nano material layer.

A thickness of the metal-plated layer will affect light penetration, light reflection and electrical conductivity. The thicker the metal-plated layer is, the lesser the light can penetrate and the better the light reflection and electrical conductivity will be. On the contrary, the thinner the metal plated layer is, the more the light can penetrate and the light reflection and electrical conductivity will get worse. As compared to 380 Å±50 Å being a thickness of a corresponding layer according to the existing holographic imaging technique, the metal-plated/nano material layer advantageously has a thickness of 150±50 Å, thereby maintaining the same holographic and laser effect and at the same time reducing frequency loss such that the IC card can be readable within a longer distance. A (Angstrom) is a unit measuring a thickness of an aluminum plated layer. 1 Å=10⁻¹⁰ m=0.1 nm.

Preferably, the holographic PET/PVC laser plastic layer also comprises a laser coating layer, positioned between the metal-plated/nano material layer and the PET/PVC base film layer; the laser coating layer is an image layer that reflects specific variable images at any selected portion of the card depending on viewing angle and lighting; the metal-plated/nano material layer is a coating layer of electrochemical aluminum, and is printed with images by laser; images printed on a laser PVC material show a glittering effect when viewed in different angles; changeable images and different colors are observed, and specific variable images can be seen at any selected portion of the card. Thus, the visual effect is good, and the anti-forgery and anti-scanning and replication ability of a transaction card can be enhanced, thereby being safer to use.

Preferably, the lower card structure also comprises the same holographic polyester (PET)/polyvinyl chloride (PVC) laser plastic layer, the same printing layer and the same PET/PVC film layer sequentially arranged on the IC chip, with the holographic PET/PVC laser plastic layer being the nearest to the IC chip and the PET/PVC film layer being farthest away from the IC chip. Therefore, both sides of the IC card have holographic and laser effect.

Alternatively, the lower card structure comprises a PET/PVC plastic layer, a printing layer and a PET/PVC film layer sequentially arranged on the IC chip, with the PET/PVC plastic layer being nearest to the IC chip and the PET/PVC film layer being farther away from the IC chip. In other words, the lower side of the IC card does not have any holographic or laser effect.

Preferably, the metal-plated/nano material layer is made with laser mold pressing rainbow holographic images and texts by utilizing laser color hologram plate making technique and mold pressing replication technique. Visible or invisible images, texts or messages are made on the IC card. Since color patches in a hologram are randomly combined, it is difficult to create two identical templates even using the same equipment. Therefore, a rainbow hologram can be used as an anti-forgery label. A laser mold pressing holographic anti-forgery label has four kinds of coloring, namely a single rainbow color, multiple rainbow colors, true color and black and white (achromatic color); the laser mold pressing holographic anti-forgery label can have a 2D image, a 3D image, multiple layers of images or be made with dynamic imaging. There is a type of gilded hologram and also a see-through type hologram, the latter one allows images and texts covered by the hologram to be readable when they are observed through the hologram; therefore, this type of see-through hologram is also called transparent hologram. Another type of see-through hologram is provided with multiple layers of transparent medium plated on the patterns of the hologram, so that the hologram is only visible under a specific viewing angle; when the viewing angle changes, an almost transparent film is visible that reveals the images and texts originally covered by the hologram. This another type of see-through hologram is even more advantageous than the first described see-through hologram.

In a testing under the same testing conditions, an IC card applying the holographic technique of the prior art having a thickness of a corresponding layer being 380 Å±50 Å has a maximum readable distance of 35-40 mm when only a single side of the card is used, and a maximum readable distance of 25-30 mm when both sides of the card are used. The IC card according to the present invention has a maximum readable distance of 40-45 mm which is 5±2 mm more than the prior art and a reduction of 1.5 Hz regarding frequency loss compared with the prior art when only a single side of the IC card has the holographic and laser effect. Also, the IC card according to the present invention has a maximum readable distance of 35-40 mm which is 10±5 mm more than the prior art and a reduction of 2.0-2.5 Hz regarding frequency loss compared with the prior art when both sides of the IC card have the holographic and laser effect.

The present invention has the following beneficial effects compared with prior art: A contactless integrated circuit (IC) card adhered with layers for showing holographic and laser images, taken into account the relationship between readable distance, reading success rate and surface effect, solving the problem of weak emission frequency of the chip after a holographic laser film and a PVC card are adhered together, and strengthening surface effect of printed images in card making industry. The IC card of the present invention is readable within a long distance, has lesser frequency loss, can be manufactured by mass production, has a good surface effect, has a long service life and possesses good anti-forging ability. The IC card of the present invention has a wide range of applicability in different fields that may use IC card.

### BRIEF DESCRIPTION OF THE DRAWINGS

FIG. 1 is a structural diagram according to embodiment 1 of the present invention.

FIG. 2 is a structural view of a holographic PET/PVC laser plastic layer according to embodiment 1 of the present invention.

FIG. 3 is a structural view of a holographic PET/PVC laser plastic layer having a laser coating layer according to embodiment 1 of the present invention.

FIG. 4 is a structural view of embodiment 2 of the present invention.

In the figures: 1: IC chip; 2: holographic PET/PVC laser plastic layer; 3: printing layer; 4: PET/PVC film layer; 5: PET/PVC plastic layer; 6: adhesive layer; 7 integration layer; 8: metal-plated/nano material layer; 9: PET/PVC base film layer; 10: laser coating layer.

### DETAILED DESCRIPTION OF THE INVENTION

The technical scheme according to the embodiments of the present invention will be clearly and comprehensively described below with reference to the accompanying drawings. Apparently, the embodiments are intended to be just some ways of implementing the present invention. The embodiments should not be considered exhaustive. Any other embodiment obtainable by a person skilled in this field of art without the need of any inventive effort should also fall within the scope of protection of the present invention.

### Embodiment 1

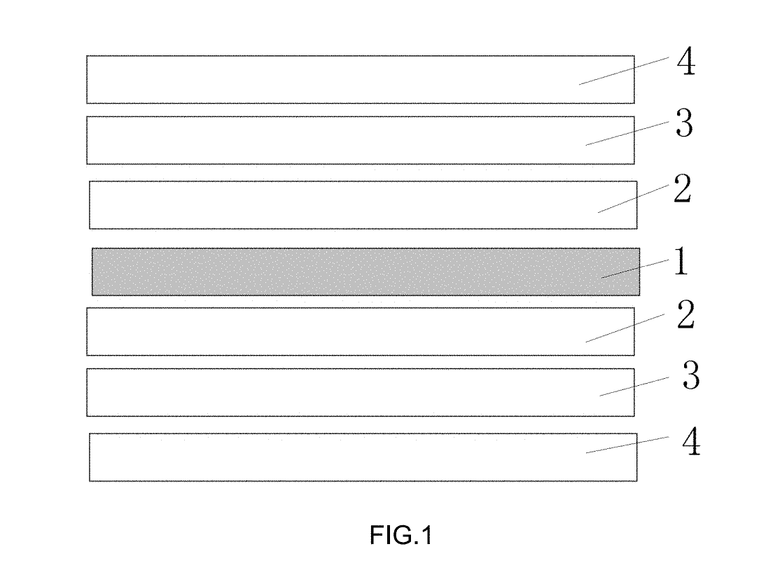

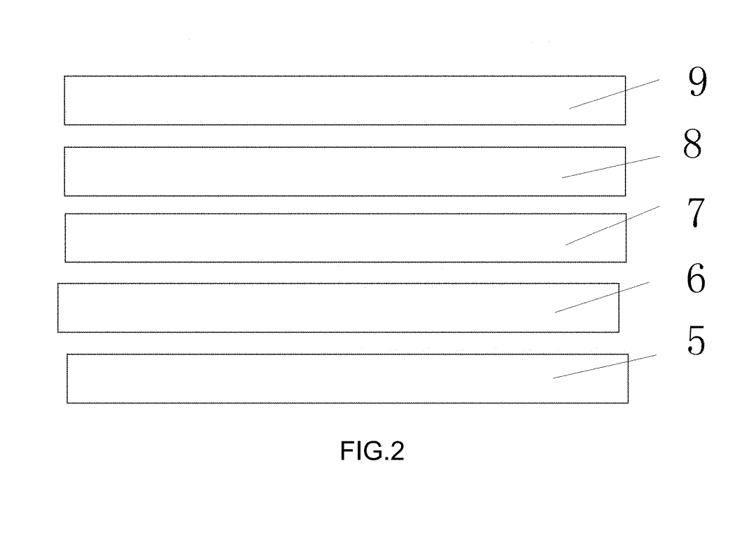

As shown in FIGS. 1-2, a contactless IC card adhered with layers for showing holographic and laser images comprises an integrated circuit (IC) chip 1 and a card structure; the IC chip 1 is disposed inside the card structure; the card structure comprises an upper card structure and a lower card structure; the upper card structure comprises a holographic polyester (PET)/polyvinyl chloride (PVC) laser plastic layer 2, a printing layer 3 and a PET/PVC film layer 4 sequentially arranged on the IC chip 1, with the holographic PET/PVC laser plastic layer 2 being the nearest to the IC chip 1 and the PET/PVC film layer 4 farthest away from the IC chip 1; the holographic PET/PVC laser plastic layer 2 is responsible for showing holographic and laser images; the printing layer 3 has images printed thereon, and the PET/PVC film layer 4 protects the holographic PET/PVC laser plastic layer 2 and the printing layer 3.

The holographic PET/PVC laser plastic layer 2 comprises a PET/PVC plastic layer 5, an adhesive layer 6, an integration layer 7, a metal-plated/nano material layer 8 and a PET/PVC base film layer 9 sequentially arranged, with the PET/PVC plastic layer 5 being nearest to the IC chip and the PET/PVC base film layer 9 being farthest away from the IC chip; the PET/PVC plastic layer 5 fixes the IC chip 1 and a general shape of the card structure; the adhesive layer 6 adheres the PET/PVC plastic layer 5 and the integration layer 7; the integration layer 7 is a functional layer that carries out pre-processing according to holographic and laser imaging requirements; the metal-plated/nano material layer 8 is a hologram layer; the PET/PVC base film layer 9 protects the PET/PVC plastic layer 5, the adhesive layer 6, the integration layer 7 and the metal-plated/nano material layer 8.

As compared to 380 Å±50 Å being a thickness of a layer according to the existing holographic imaging technique, the metal-plated/nano material layer 8 advantageously has a thickness of 150±50 Å, thereby maintaining the same holographic and laser effect and at the same time reducing frequency loss such that the IC card can be readable within a longer distance.

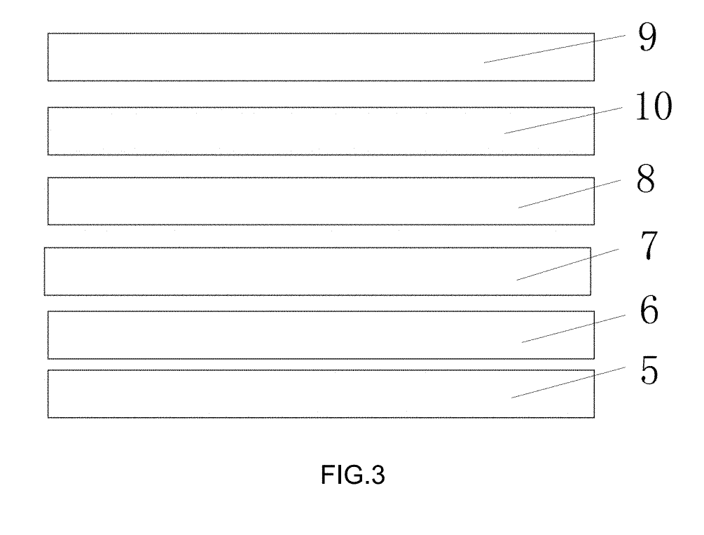

As shown in FIG. 3, the holographic PET/PVC laser plastic layer 2 also comprises a laser coating layer 10, positioned between the metal-plated/nano material layer 8 and the PET/PVC base film layer 9; the laser coating layer 10 is an image layer that reflects specific variable images at any selected portion of the card depending on viewing angle and lighting; the material layer 8 is a coating layer of electrochemical aluminum, and is printed with images by laser; images printed on a laser PVC material show a glittering effect when viewed in different angles; changeable images and different colors can be observed, and specific variable images can be seen at any selected portion of the card. Thus, the visual effect is good, and the anti-forgery and anti-scanning and replication ability of a transaction card can be enhanced, thereby being safer to use.

As shown in FIG. 1, the lower card structure also comprises the same holographic polyester (PET)/polyvinyl chloride (PVC) laser plastic layer 2, the same printing layer 3 and the same PET/PVC film layer 4 sequentially arranged on the IC chip 1, with the holographic PET/PVC laser plastic layer 2 being the nearest to the IC chip 1 and the PET/PVC film layer 4 being farthest away from the IC chip 1. As such, both sides of the IC card will have the holographic and laser effect.

The metal-plated/nano material layer 8 is made with laser mold pressing rainbow holographic images and texts by utilizing laser color hologram plate making technique and mold pressing replication technique. Visible or invisible images, texts or messages are made on the IC card. Since color patches in a hologram are randomly combined, it is difficult to create two identical templates even using the same equipment. Therefore, a rainbow hologram can be used as an anti-forgery label. A laser mold pressing holographic anti-forgery label has four kinds of coloring, namely a single rainbow color, multiple rainbow colors, true color and black and white (achromatic color); the laser mold pressing holographic anti-forgery label can have a 2D image, a 3D image, multiple layers of images or be made with dynamic imaging. There is a type of gilded hologram and also a see-through type hologram, the latter one allows images and texts covered by the hologram to be readable when they are observed through the hologram; therefore, this type of see-through hologram is also called transparent hologram. Another type of see-through hologram is provided with multiple layers of transparent medium plated on the patterns of the hologram, so that the hologram is only visible under a specific viewing angle; when the viewing angle changes, an almost transparent film is visible that reveals the images and texts originally covered by the hologram. This another type of see-through hologram is even more advantageous than the first described see-through hologram.

### Embodiment 2

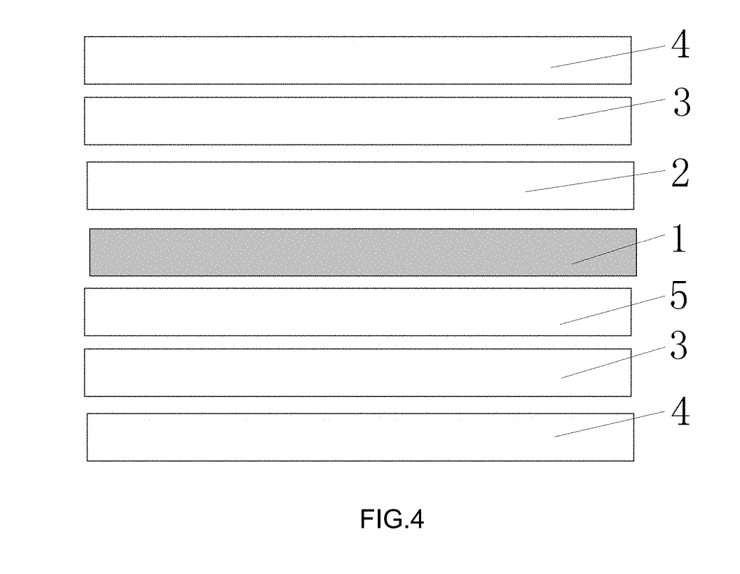

With reference to FIG. 4, embodiment 2 is different from embodiment 1 in that, the lower card structure comprises a PET/PVC plastic layer 5, a printing layer 3 and a PET/PVC film layer 4 sequentially arranged on the IC chip 1, with the PET/PVC plastic layer being nearest to the IC chip 1 and the PET/PVC film layer being farther away from the IC chip 1. In other words, the lower side of the IC card does not have any holographic or laser effect.

In a testing under the same testing conditions, and given that the metal-plated/nano material layer is an aluminum plated layer, an IC card applying the holographic technique of the prior art having a thickness of a corresponding layer being 380 Å±50 Å has a maximum readable distance of 35-40 mm when only a single side of the card is used, and a maximum readable distance of 25-30 mm when both sides of the card are used. The IC card according to the present invention has a maximum readable distance of 40-45 mm which is 5±2 mm more than the prior art and a reduction of 1.5 Hz regarding frequency loss compared with the prior art according to embodiment 2 where only a single side of the IC card has the holographic and laser effect. Also, the IC card according to the present invention has a maximum readable distance of 35-40 mm which is 10±5 mm more than the prior art and a reduction of 2.0-2.5 Hz regarding frequency loss compared with the prior art according to embodiment 1 of the present invention where both sides of the IC card have the holographic and laser effect.

The embodiments of the present invention are shown and described above. It should be understood that, various changes, alterations, modifications and replacements of the described embodiments in accordance with the principle and teachings of the present invention can be carried out by a person skilled in this field of art. The scope of the present invention is defined by the claims and their equivalence.

What is claimed is:

1. A contactless integrated circuit (IC) card adhered with layers for showing holographic and laser images, comprising an IC chip and a card structure; the IC chip is disposed inside the card structure; the card structure comprises an upper card structure and a lower card structure; the upper card structure comprises a holographic polyester (PET)/polyvinyl chloride (PVC) laser plastic layer, a printing layer and a PET/PVC film layer sequentially arranged on the IC chip, with the holographic PET/PVC laser plastic layer being the nearest to the IC chip and the PET/PVC film layer farthest away from the IC chip; the holographic PET/PVC laser plastic layer is responsible for showing holographic and laser images; the printing layer has images printed thereon, and the PET/PVC film layer protects the holographic PET/PVC laser plastic layer and the printing layer.

2. The contactless integrated circuit (IC) card as in claim 1, wherein the holographic PET/PVC laser plastic layer comprises a PET/PVC plastic layer, an adhesive layer, an integration layer, a metal-plated/nano material layer and a PET/PVC base film layer sequentially arranged, with the PET/PVC plastic layer being nearest to the IC chip and the PET/PVC base film layer being farthest away from the IC chip; the PET/PVC plastic layer fixes the IC chip and a general shape of the card structure; the adhesive layer adheres the PET/PVC plastic layer and the integration layer; the integration layer is a functional layer that carries out pre-processing according to holographic and laser imaging requirements; the metal-plated/nano material layer is a hologram layer; the PET/PVC base film layer protects the PET/PVC plastic layer, the adhesive layer, the integration layer and the metal-plated/nano material layer.

3. The contactless integrated circuit (IC) card as in claim 2, wherein the metal-plated/nano material layer has a thickness of 150±50 Å.

4. The contactless integrated circuit (IC) card as in claim 3, wherein the holographic PET/PVC laser plastic layer also comprises a laser coating layer, positioned between the metal-plated/nano material layer and the PET/PVC base film layer; the laser coating layer is an image layer that reflects specific variable images at any selected portion of the card depending on viewing angle and lighting; the metal-plated/nano material layer is a coating layer of electrochemical aluminum, and is printed with images by laser; images printed on a laser PVC material show a glittering effect when viewed in different angles; changeable images and different colors are observed, and specific variable images are seen at any selected portion of the card; the visual effect is good, and the anti-forgery and anti-scanning and replication ability of a transaction card is enhanced, thereby being safer to use.

5. The contactless integrated circuit (IC) card as in claim 4, wherein the metal-plated/nano material layer is made with laser mold pressing rainbow holographic images and texts by utilizing laser color hologram plate making technique and mold pressing replication technique.

6. The contactless integrated circuit (IC) card as in claim 1, wherein the lower card structure also comprises the same holographic polyester (PET)/polyvinyl chloride (PVC) laser plastic layer, the same printing layer and the same PET/PVC film layer sequentially arranged on the IC chip, with the holographic PET/PVC laser plastic layer being the nearest to the IC chip and the PET/PVC film layer being farthest away from the IC chip.

7. The contactless integrated circuit (IC) card as in claim 2, wherein the lower card structure comprises the PET/PVC plastic layer, the printing layer and the PET/PVC film layer sequentially arranged on the IC chip, with the PET/PVC plastic layer being nearest to the IC chip and the PET/PVC film layer being farther away from the IC chip.
